(19) United States
(12) Patent Application Publication
(10) Pub. No.: US 2015/0211714 A1
(43) Pub. Date: Jul. 30, 2015

(54) Light-Emitting Device With Partial Roughened Illumination Surface

(71) Applicant: Avago Technologies General IP (Singapore) Pte. Ltd, Singapore (SG)

(72) Inventors: Keat Chuan Ng, Penang (MY); Chin Ewe Phang, Penang (MY); Kheng Leng Tan, Penang (MY); Boon Keat Tan, Singapore (SG); Kum Soon Wong, Pinang (MY)

(73) Assignee: Avago Technologies General IP (Singapore) Pte. Ltd, Singapore (SG)

(21) Appl. No.: 14/163,439

(22) Filed: Jan. 24, 2014

(51) Int. Cl. F21V 13/04; F21S 8/10

(52) U.S. Cl. CPC F21V 13/04; F21S 48/215; F21Y 2101/02

(57) ABSTRACT

In one embodiment, a light-emitting device having a reflector, an emitter and an encapsulant is disclosed. The encapsulant may have a plurality of optical structures. Each of the plurality of optical structures may be configured to attenuate light transmitting towards a first direction by re-directing towards a second direction. In another embodiment, a flashlight having a roughened area with micro-optics is disclosed. Each of the micro-optics is configured to redirect light transmitting towards a direction forming an angle relative to a longitudinal axis to a point along the longitudinal axis. In yet another embodiment, a lighting-emitting device having roughened area to reduce light along a longitudinal axis is disclosed.

### BACKGROUND

A light-emitting diode (referred to hereinafter as LED) represents one of the most popular light-emitting devices today. In recent years, the luminous efficacy of LEDs, defined in lumens per Watt, has increased significantly from 20 lumens per Watt (approximately the luminous efficacy of an incandescent light bulb) to over 500 lumens per Watt, which greatly exceeds the luminous efficacy of a fluorescent light at 60 lumens per Watt. In addition to the luminous efficacy, LEDs may be superior or preferable compared to traditional light sources because of the small form factor. As a result, LEDs are finding their ways to almost all applications that require light. For example, LEDs had rarely been used in automotive applications due to the stringent automotive requirements a decade ago, but today most of the lighting apparatuses in automotive use LEDs. Similarly, the idea of having LEDs to replace streetlights and flashlights from lighthouse for seaport communication may be unthinkable due to the requirement of extremely high intensity of light a decade ago, but that has changed.

Due to the small form factor, optical lens may be placed close to the light sources. Various optical designs that were not possible with traditional light sources may become possible for the LEDs. With new optical designs, LEDs may be one of the most appealing light sources nowadays.

### BRIEF DESCRIPTION OF THE DRAWINGS

Illustrative embodiments by way of examples, not by way of limitation, are illustrated in the drawings. Throughout the description and drawings, similar reference numbers may be used to identify similar elements. The drawings may be simplified illustrative views rather than precise engineering drawings. The drawings are for illustrative purpose to assist understanding and may not necessarily be drawn per actual scale.

FIG. 1A shows an illustrative block diagram of a light-emitting device having a plurality of optical structures;

FIG. 1B shows how each of the plurality of optical structures may be configured to direct light towards a common direction;

FIG. 2A illustrates a cross-sectional view of a light-emitting device with substantially half of an illumination surface covered by a plurality of optical structures;

FIG. 2B illustrates a top view of the light-emitting device shown in FIG. 2A;

FIG. 2C illustrates how the light-emitting device shown in FIG. 2A arranged substantially vertically relative to a horizontal axis;

FIG. 2D illustrates a radiation pattern of the light-emitting device shown in FIG. 2A;

FIG. 2E illustrates an electronic display system having the light-emitting device shown in FIG. 2A;

FIG. 3A illustrates a cross-sectional view of a flashlight having a roughened surface;

FIG. 3B illustrates a top view of the flashlight shown in FIG. 3A;

FIG. 3C illustrates a radiation pattern of the flashlight shown in FIG. 3A;

FIG. 3D illustrates a light communicating system of a port having the flashlight shown in FIG. 3A;

FIG. 4A illustrates a cross-sectional view of a light-emitting device having a roughened surface;

FIG. 4B illustrates a top view of the flashlight shown in FIG. 4A;

FIG. 4C illustrates a radiation pattern of the light-emitting device shown in FIG. 4A;

FIG. 4D illustrates a tail lamp of a vehicle having the light-emitting device shown in FIG. 4A; and

FIG. 5 illustrates a method for making light-emitting device that direct light to one side.

### DETAILED DESCRIPTION

Light-emitting devices may be implemented using various packaging technologies such as a plastic leaded chip carrier (herein after PLCC) package, a ball grid array package (herein after BGA), a pin grid array package (herein after PGA), a quad flat pack (herein after QFP), a printed circuit board (herein after PCB) package and so on. Certain packages, for example PLCC packages, may comprise a lead frame over a molded polymer material such as Polyphthalamide (herein after PPA), Polyamide or Epoxy resin encapsulant like MG 97. For surface mount type, leads extending from the lead frame may be bent so that the light-emitting devices can be soldered on a substrate without through-holes. Light-emitting devices based on other packaging technologies such as a BGA and PGA may comprise a substrate having conductive traces without a lead frame. Teaching throughout the specification about an LED may be applicable to a light source packaging, including at least all various types of packaging technologies discussed above.

The packaged LED may be used for various illumination purposes such as backlighting, camera flash, indicator light, solid-state lighting and other similar applications, where illumination may be desired. A light-emitting device should not be limited to devices for lighting purposes, but also other optical device that may emit a radiation of invisible light. For example, a light-emitting device may comprise a proximity sensor, an encoder or other optical device involving an emitter configured to emit a visible or invisible light. However, a light-emitting device may be an electronic component and may be contrasted from a lighting fixture. A lighting fixture may be a lighting apparatus having packaged LED with additional reflectors or electric circuits for lighting purposes. Lighting fixtures with LED become more popular for mood lighting, wall lighting, artifact or ornament lighting, or other similar illumination purposes. In particular, for places such as factories, street lampposts, gas stations where the lighting fixtures may not be easily accessible, lighting fixtures with LED may be getting more popular.

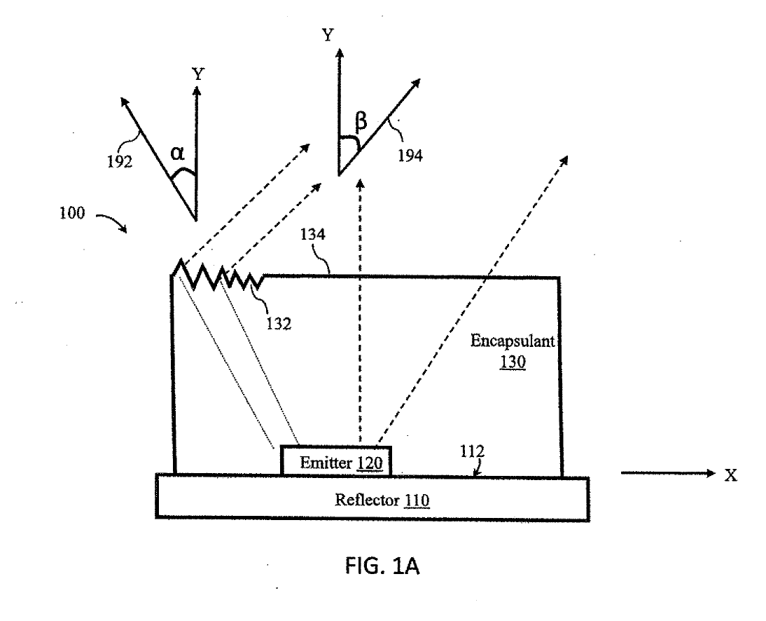

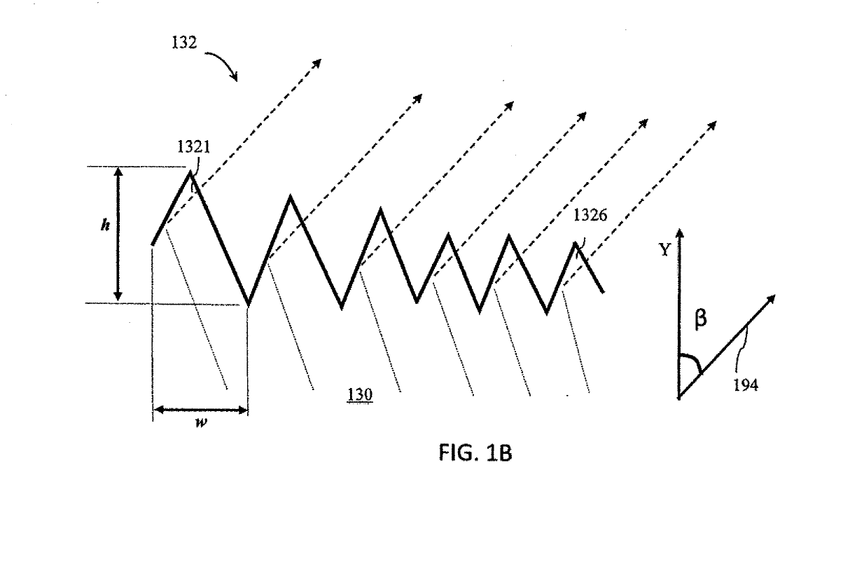

FIG. 1A shows an illustrative block diagram of a light-emitting device 100. The light-emitting device 100 may comprise a reflector 110, an emitter 120 and an encapsulant 130 encapsulating the emitter 120. The reflector 110 may comprise a reflector surface 112 and the emitter 120 may be attached on the reflector surface 112. The reflector 110 may be a substrate 110, or a body 110 as a primary structure for providing support to the emitter 120 having substantially reflective surface. For example, the reflector 110 may be a lead frame molded structure having the reflective surface 112. Alternatively, the reflector 110 may be a printed circuit board with a substantially reflective surface 112. In one embodiment, the printed circuit board may reflect more than 50% of light falling on the surface. In another embodiment, the reflector 110 may comprise PPA that may reflect more than 80% of light.

The emitter 120 may be a light source or a radiation source such as an LED configured to emit a radiation. The emitter 120 may be configured to emit electromagnetic radiation waves that may be invisible to human eyes such as infrared, ultra-violet or radiation having other invisible wavelength. Alternatively, the emitter 120 may be configured to emit electromagnetic radiation of visible wavelength. The emitter 120 may be coupled with the reflector 110 and may be configured to emit light towards an illumination direction Y. As shown in FIG. 1A, the illumination direction Y may be substantially orthogonal relative to the reflector 110.

The encapsulant 130 may be substantially transparent. In one embodiment, the encapsulant 130 may have approximately more than ninety percent of transmissivity. The encapsulant 130 may comprise substantially silicone material, epoxy or other substantially transparent material. The encapsulant 130 may be encapsulating the emitter 120 on the reflector surface 112. The encapsulant 130 may be encapsulating the entire reflector surface 112 or in another embodiment, the encapsulant 130 may be encapsulating partially the reflector surface 112. The encapsulant 130 may comprise an illumination surface 134 substantially facing the illumination direction Y. The illumination surface 134 of the encapsulant 130 may be distanced away from the reflector surface 112. In the embodiment shown in FIG. 1A, the illumination surface 134 may be substantially in parallel with the reflector surface 112. Hence, the illumination surface 134 may be substantially orthogonal relative to the illumination direction Y.

The encapsulant 130 may comprise a plurality of optical structures 132 formed on at least a portion of the encapsulant 130. In the embodiment shown in FIG. 1A, the plurality of optical structures 132 may be formed on a portion of the illumination surface 134 of the encapsulant 130. In one embodiment, the plurality of optical structures 132 may be formed on at least half of the illumination surface 134. Each of the plurality of optical structures 132 may be configured to attenuate light transmitting towards a first direction 192 by redirecting the light towards a second direction 194 respectively as shown in FIG. 1A. As shown in FIG. 1A, the first direction 192 may form an angle α of less than ninety degrees relative to the illumination direction Y. In one embodiment, the angled formed between the first direction 192 and the illumination direction Y may be less than forty five degrees.

The second direction 194 may form an angle β of less than ninety degrees relative to the illumination direction Y. In another embodiment, the angled formed between the second direction 194 and the illumination direction Y may be less than forty five degrees. The first direction 192 and the second direction 194 may form an angle that may be less than one hundred twenty degrees in yet another embodiment.

As shown in FIG. 1B, each of the plurality of optical structures 132 may be configured to direct light towards a common direction or in the second direction 194. If the light is not redirected by the plurality of optical structures 132, the light may be transmitted to the first direction 192. As a result, less light may be transmitted towards the first direction 192 resulting in more light, which may be transmitted towards the second direction 194.

The plurality of optical structures 132 may be micro-optics, which may be stamped, molded, hot-pressed or otherwise formed on the encapsulant 130. Each of the plurality of optical structures 132 may have a feature size less than approximately five microns. For example, each of the plurality of optical structures 132 may have a feature height h that may be less than approximately five microns and a feature width w that may be less than approximately five microns. In one embodiment the height h and width w may be less than approximately one micron. In addition, as each of the plurality of optical structures 132 may be located at different position from the emitter 120, each of the plurality of optical structures 132 may have a different size or shape in accordance to a distance from the emitter 120. Depending on the location of each of the plurality of optical structures 132, the optical design requirement may vary and in order to redirect light towards a common direction 194, the shape and/or the size of each of the plurality of optical structures 132 may need to be adjusted accordingly. For example, in the embodiment shown in FIG. 1B, the optical structure 1326 formed nearer to the emitter 120 may have a smaller feature height h compared to the optical structure 1321 formed further away from the emitter 120.

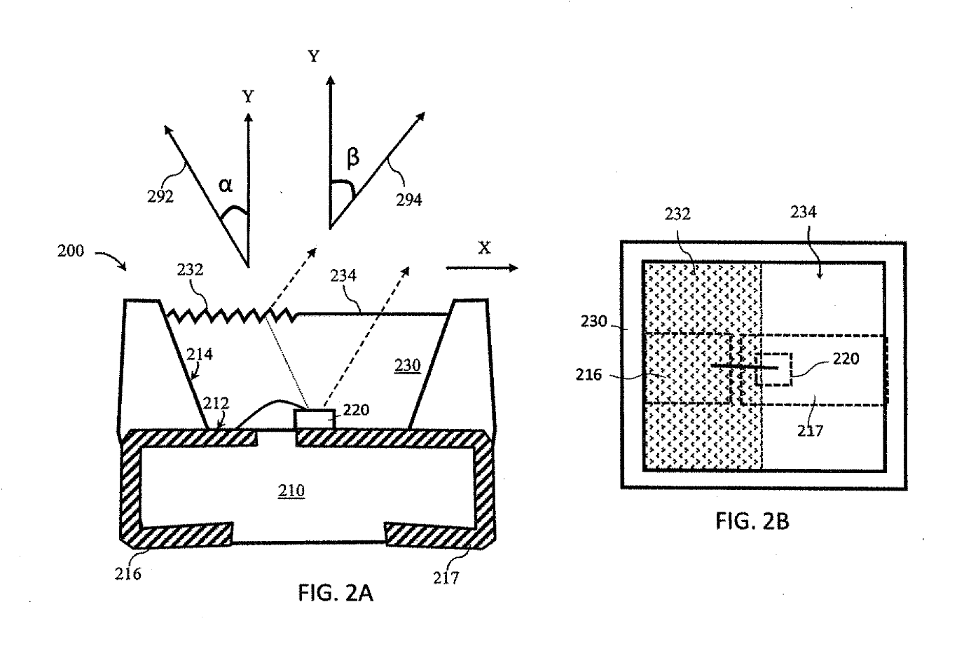

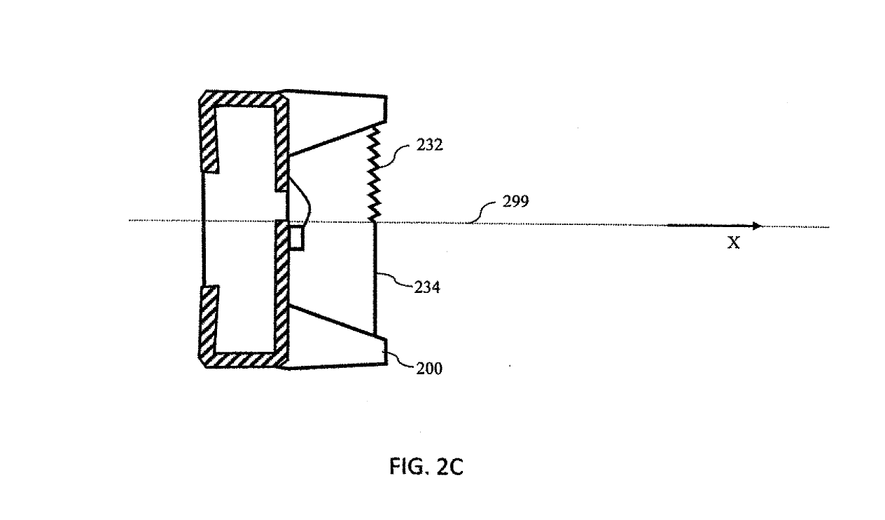

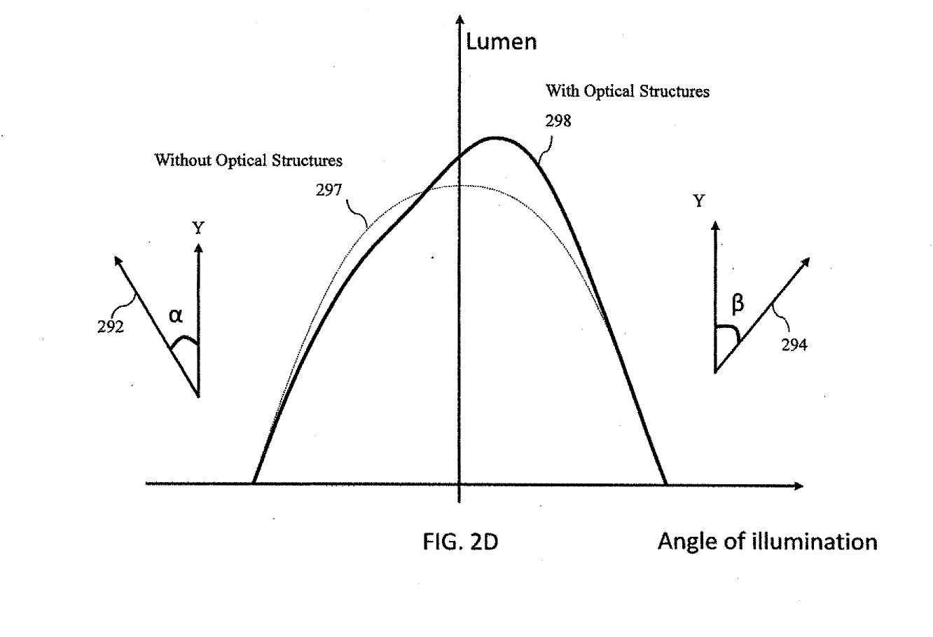

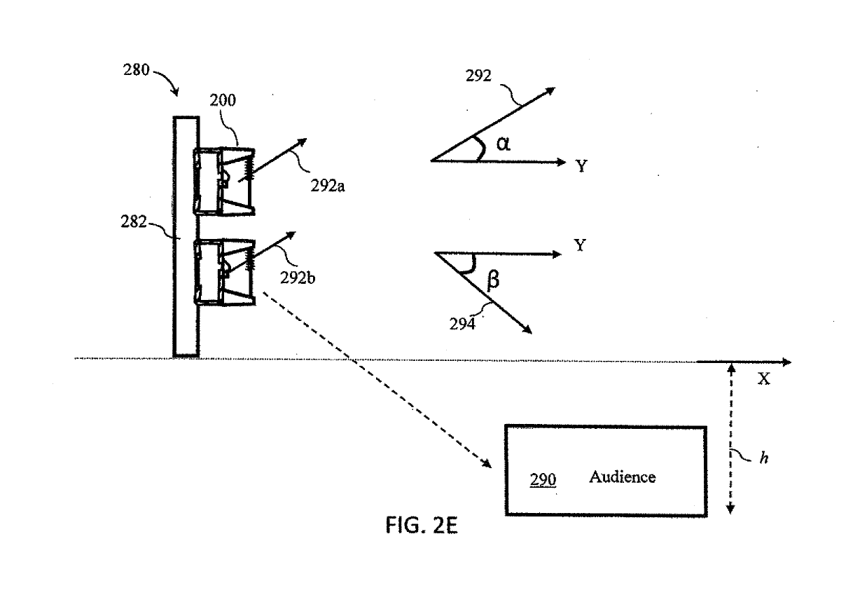

FIG. 2A illustrates a cross-sectional view of a light-emitting device 200. A top view of the light-emitting device 200 is shown in FIG. 2B. The light-emitting device 200 may be an optocoupler, a proximity sensor or other optical devices that may be configured to emit light or a radiation. The light-emitting device 200 may comprise a plurality of conductors 216, 217, an emitter 220, a body 210 and an encapsulant 230, “Conductors” 216, 217 as used herein in reference to the light-emitting device 200 may refer to what can electrically connect the emitter 220 to an external power source (not shown). In PLCC packages, the plurality of conductors 216, 217 may be leads forming part of lead frames but in other packaging technologies, for example printed circuit boards (referred hereinafter as “PCB”), the plurality of conductors 216, 217 may be electrically conductive traces formed on the PCBs. The scope of the invention should not be limited to any specific forms illustrated, but should be taken into consideration various other technologies, other forms of packaging either presently available, or developed in future.

In the embodiment shown in FIG. 2A, the plurality of conductors 216, 217 may be made of electrically and thermally conductive material, such as steel, copper, metal or a metal alloy, a metal compound or other similar material. The plurality of conductors 216, 217 may be formed using any conventional stamping, cutting, etching or other similar process that is known in the art. For surface mount purposes, the plurality of conductors 216, 217 may be bent to define a bottom portion for attaching to external surfaces (not shown).

The “body” 210 as used herein in reference to a component of a light-emitting device 200 may refer to a respective primary structure, which provides structural support for other components of the light-emitting device 200. In another embodiment, the body 210 may be a substrate such as a PCB. Each body 210 may be a respective integral single piece structure. The body 210 may be formed using an opaque material such as PPA, polyamide, epoxy resin, plastic and other similar material. The body 210 may be formed encapsulating or surrounding the plurality of conductors 216, 217 using an injection mold or other similar process. Alternatively, the body 210 may be pre-formed and may be subsequently assembled to form the light-emitting device 200. The body 210 may extend planarly in the direction of a horizontal axis X.

The body 210 may comprise a reflective material such that the body 210 may comprise at least one reflective surface 212 for directing light towards an illumination direction Y. A portion of the plurality of conductors 216, 217 may be made larger and may form a portion of the at least one reflective surface 212. As shown in FIG. 2A, the body 210 may comprise an additional side reflective surface 214 for directing light towards the illumination direction Y. In the embodiment shown in FIG. 2A, the body 210 may be made from reflective material such as PPA and may be designated as reflector.

In the embodiment shown in FIG. 2A, the encapsulant 230 may comprise an illumination surface 234. As shown in FIG. 2A, the illumination surface 234 may be substantially parallel to the horizontal axis X and the at least one reflective surface 212. The light-emitting device 200 may comprise a plurality of optical structures 232 formed on the illumination surface 234. As shown in FIG. 2A and FIG. 2B, approximately half of the illumination surface 234 may be covered by the plurality of optical structures 232. The remaining half of the illumination surface 234 may be substantially smooth. Each of the plurality of optical structures 232 may be configured to attenuate light transmitting towards a first direction 292 by redirecting the light towards a second direction 294 respectively. The first direction 292 may form an angle α of less than ninety degrees relative to the illumination direction Y, whereas, the second direction 294 may form an angle β of less than ninety degrees relative to the illumination direction Y.

FIG. 2C illustrates a vertical arrangement of the light-emitting device 200. As shown in FIG. 2C, when the light-emitting device 200 is arranged substantially vertically relative to a horizontal axis X with the illumination surface 234 extending substantially vertically relative to the horizontal axis in the vertical arrangement, the portion of the illumination surface 234 may comprise the plurality of optical structures 232 that may be situated above the horizontal axis X. The portion of the illumination surface 234 below the horizontal axis X may comprise substantially a smooth surface.

In this vertical arrangement, the plurality of optical structures 232 may be configured to redirect light towards a direction below the horizontal axis X. The horizontal axis X shown in FIG. 2C may extend through a center axis 299 of the illumination surface 234. FIG. 2D illustrates a radiation pattern 298 of the light-emitting device 200 having the plurality of optical structures 232. The radiation pattern 298 may be illustrated in FIG. 2D using a solid line in a radiation graph showing a horizontal “angle of illumination” axis and a vertical “lumen intensity” axis. The angle of illumination may be the angle formed between a light ray relative to the illumination direction Y. For reference purposes, a radiation pattern 297 of a similar device without the Plurality of optical structure 232 is shown in dashed line.

Without the plurality of optical structures 232, the radiation pattern 297 may be substantially symmetrical. However, with the plurality of optical structures 232 formed on approximately half of the illumination surface 234, the radiation pattern 298 may be asymmetrical. The illumination pattern 298 may be higher on one side of the center axis 299 at the expense of the other side as illustrated in FIG. 2D. As explained in FIG. 2A, the plurality of optical structures 232 may attenuate light transmitted towards the first direction 292 (which is shown to the left of the radiation graph) by redirecting the light towards the second direction 294 (which is shown to the right of the radiation graph).

The plurality of optical structures 232 may extend planarly on the illumination surface 234 in an asymmetrical manner. For example, the horizontal axis X may not extend through the center axis 299 as shown in FIG. 2C in another embodiment. For example, the horizontal axis X may extend through the illumination surface 234 such that approximately less than half of the illumination surface may be above the horizontal axis X. In this example, the plurality of optical structures 232 may be formed in approximately less than half of the illumination surface 234. In another embodiment, approximately less than thirty percent of the illumination surface 234 may be smooth with the majority of the remaining illumination surface 234 covered by the plurality of optical structures 232.

FIG. 2E illustrates an electronic display system 280 having the light-emitting device 200 shown in FIG. 2A. The electronic display system 280 may comprises at least one additional light-emitting device 200 attached on a substrate 282. As shown in FIG. 2E, the light-emitting device 200 and the at least one additional light-emitting device 200 may be arranged in a similar manner so as to attenuate light transmitted towards a common direction 292a, 292b that extends substantially in parallel to the first direction 292 by redirecting the light towards the second direction 294. The electronic display system 280 may be placed at a height, h that may be above audience 290. The audience may view the display system 280 from the second direction 294. Therefore, the plurality of optical structures 232 may increase the efficiency of the display system 280 by channeling more light to the audience 290 while retaining the vertical arrangement of the electronic display system 280.

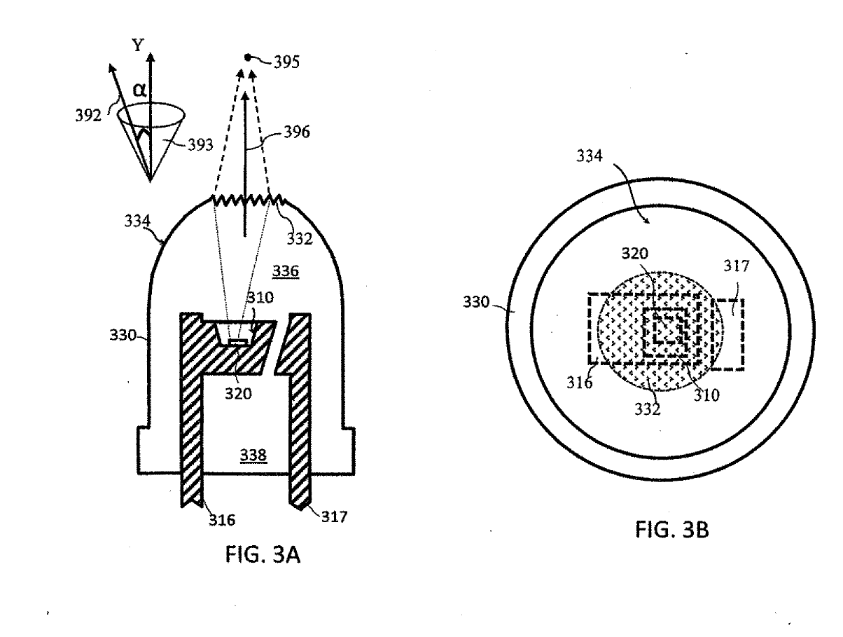

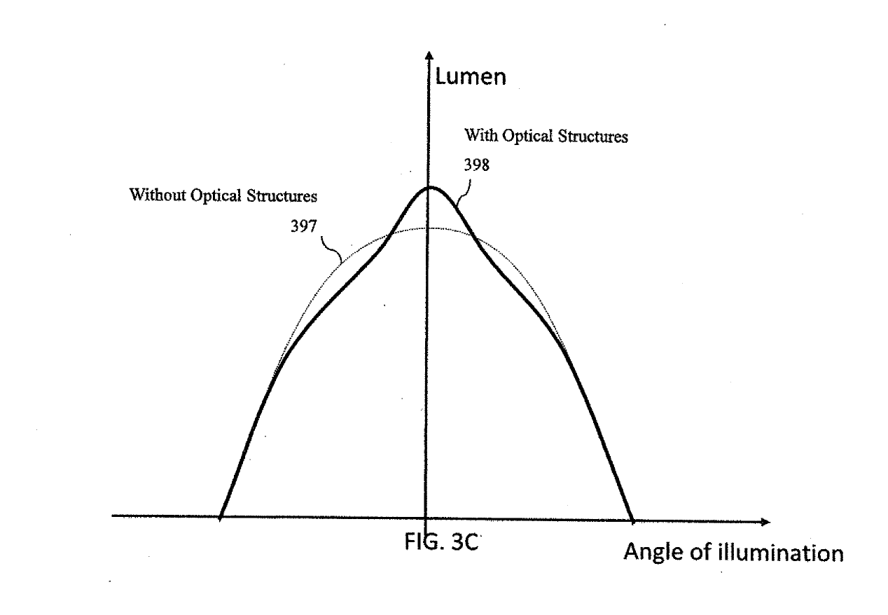

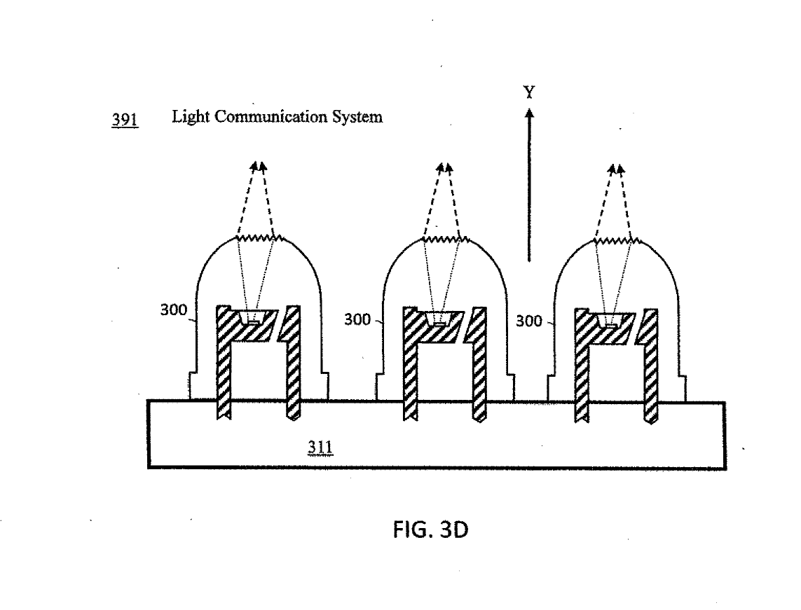

FIG. 3A illustrates a cross-sectional view of a flashlight 300. A top view of the flashlight 300 is shown in FIG. 3B. Referring to FIG. 3A and FIG. 3B, the flashlight 300 may comprise an emitter 320, a plurality of conductors 316, 317 and an encapsulant 330. The encapsulant 330 may be configured to encapsulate the emitter 320 and at least partially the plurality of conductors 316, 317. The emitter 320 may be configured to emit light. A portion of the reflector 316 may comprise a reflector 310 configured to direct light emitted from the emitter 320 towards an illumination direction Y. In the embodiment shown in FIG. 3A, the reflector 310 may be a reflector cup encapsulated entirely within the encapsulant 330.

The encapsulant 330 may comprise an illumination surface 334 facing the illumination direction Y. As shown in FIG. 3A, the encapsulant 330 may comprise a lens portion 336 configured to collimate or to focus light. The illumination surface 334 may be a portion of the lens 336 having a curvature surface. The encapsulant 330 may comprise a roughened area 332. Optionally, the roughened area 332 may be formed within the lens portion 336. The illumination surface 334 outside the roughened area 332 may be substantially smooth.

The roughened area 332 may comprise a plurality of micro-optics 332. The plurality of micro-optics 332 may be characterized by a feature size of equal to or less than few microns. The plurality of micro-optics 332 may be hot-pressed on the illumination surface 334. The plurality of micro-optics 332 may be formed using other methods such as molding or stamping. The flashlight 300 may extend along a longitudinal axis 396. In the embodiment shown in FIG. 3A, the longitudinal axis 396 may be substantially in parallel with the illumination direction Y. The roughened area 332 and the plurality of micro-optics 332 may be configured to redirect light such that light passing through the roughened area 332 may be redirected by the plurality of micro-optics 332. In the embodiment shown in FIG. 3A, each of the micro-optics 332 may be configured to attenuate light directed towards a first direction 392 forming an angle α relative to the illumination direction Y by redirecting the light towards a point 395 substantially further away from the flashlight 300. The point 395 may be disposed along the longitudinal axis 396.

As shown in FIG. 3B, the roughened area 332 may be substantially circular in shape. The roughened area 332 and the lens portion 336 may be substantially co-axially aligned around the longitudinal axis 396. In the embodiment shown in FIG. 3A, the roughened area 332 and the lens portion 336 may be substantially co-axially aligned around the emitter 320 and/or the longitudinal axis 396. The plurality of micro-optics 332 may be radially symmetrical around the emitter 320, so as light transmitting towards the first direction 392 and forming an angle of a relative to the illumination direction Y may be redirected. Therefore, the light transmitting towards the first direction 392 in combination may form a conical plane 393 as shown in FIG. 3A relative to the illumination direction Y.

FIG. 3C illustrates a radiation pattern 398 of the flashlight 300 shown in FIG. 3A. The radiation pattern 398 may be illustrated in FIG. 3C using a solid line in a radiation graph showing a horizontal “angle of illumination” axis and a vertical “lumen intensity” axis. The angle of illumination may be the angle formed between a light ray relative to the illumination direction Y. For reference purpose, a radiation pattern 397 of a similar device without the roughened area 332 is shown in dashed line. As shown in FIG. 3C, the graph corresponding to the surrounding of the roughen area 332 may have less intensity compared to the radiation pattern 397 without the roughened area or micro-optics 332. However, the radiation pattern 398 may form a peak along the longitudinal axis 396 where the angle of illumination may be approximately close to zero. The peak may be substantially higher compared to the radiation pattern 397 without the roughened area 332. In other words, the flashlight 300 may have relatively high intensity around the longitudinal axis 396.

The flashlight 300 shown in FIG. 3A and FIG. 3B may form a portion of a light communicating system 391 of a seaport shown in FIG. 3D. The light communicating system 391 may comprise a plurality of flashlight 300 disposed on a substrate 311. Each of the flashlights 300 may be facing a common illumination direction or the illumination direction Y. The light communicating system 391 may be arranged such that the illumination direction Y is directed to a ship (not shown) that may be spaced relatively further away. The roughened area 332 may enable the light to be concentrated towards the illumination direction Y so that the light signal may be received even at a further distance compared to a flashlight without the plurality of micro-optics 332.

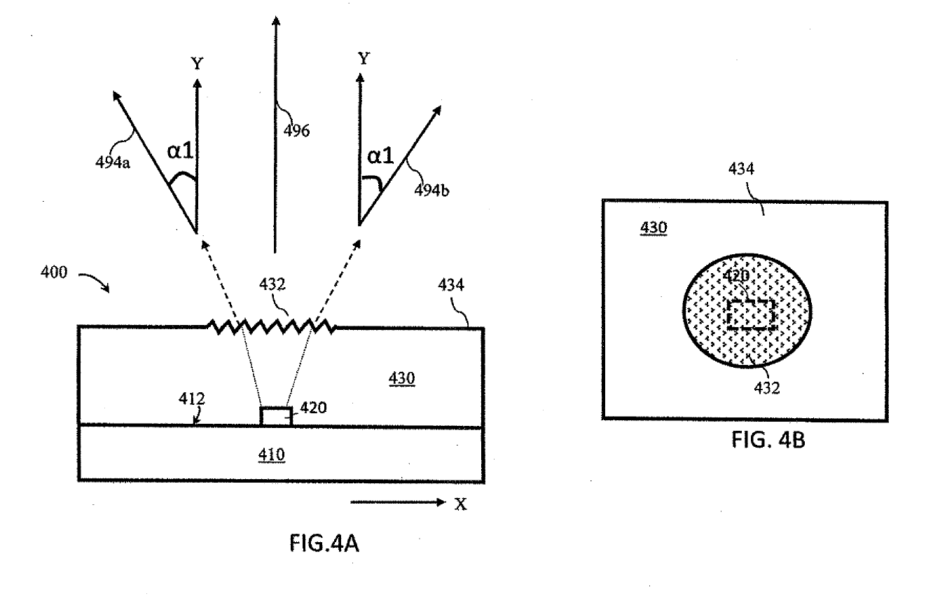

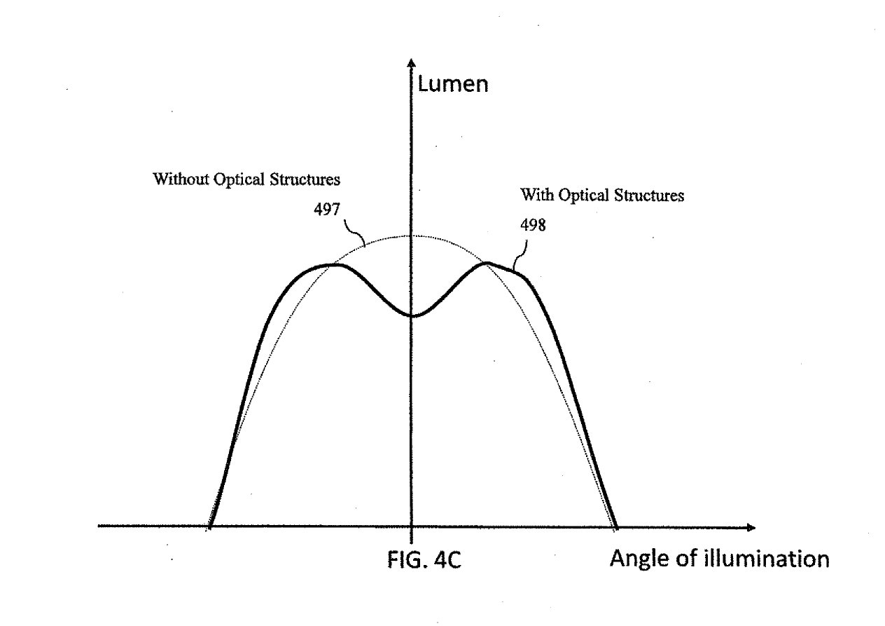

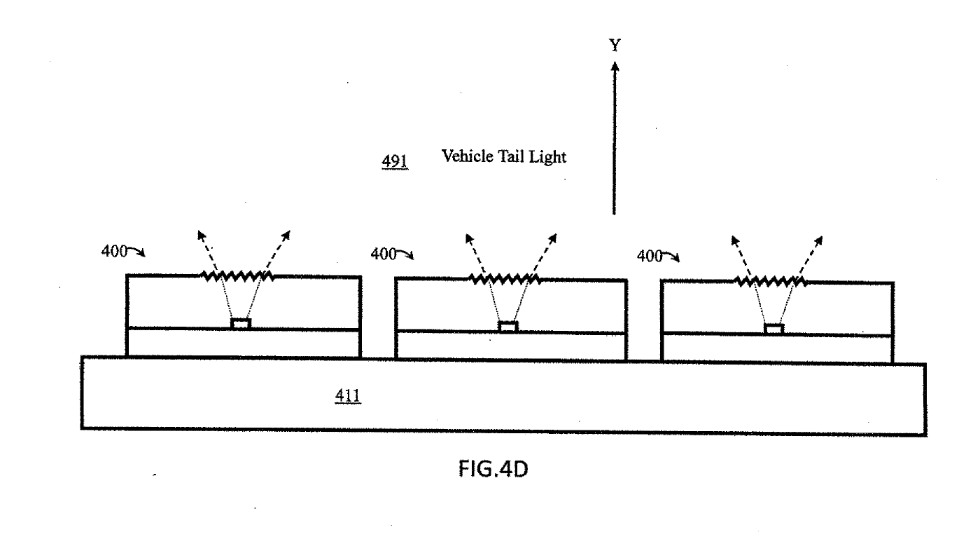

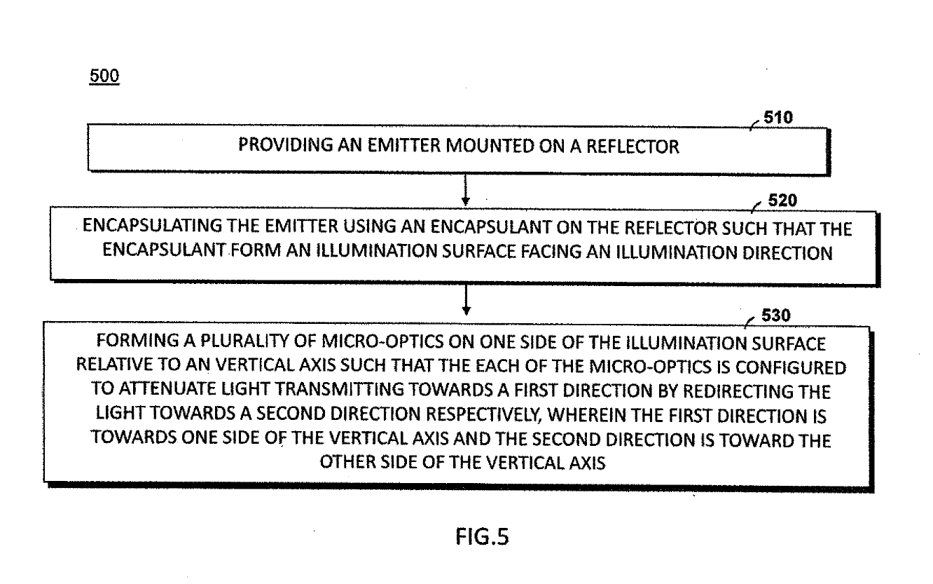

FIG. 4A illustrates a cross-sectional view of a light-emitting device 400. A top view of the light-emitting device 400 is shown in FIG. 4B. Referring to FIG. 4A and FIG. 4B, the light-emitting device 400 may comprise an emitter 420, a reflector 410 and an encapsulant 430. The encapsulant 430 may be configured to encapsulate the emitter 420 and at least a portion of the reflector 410. The emitter 420 may be configured to emit light. The reflector 410 may be configured to direct light emitted from the emitter 420 towards an illumination direction Y. The encapsulant 430 may comprise an illumination surface 434. The illumination surface 434 and the reflector 410 may be facing the illumination direction Y as shown in FIG. 4A.

The illumination surface 434 may comprise a roughened area 432 having a plurality of micro-optics 432 approximating the emitter 420. As shown in FIG. 4A, the emitter 420 and the roughened area 432 may be formed substantially along a longitudinal axis 496. The longitudinal axis 496 may be substantially parallel to the illumination direction Y. The roughened area 432 may be formed in a substantially circular shape with the longitudinal axis 496 located at a central region of the circular shape. The illumination surface 434 surrounding the roughened area 432 may be substantially smooth. As illustrated in FIG. 4A, each of the micro-optics 432 may be configured to attenuate light directed towards the longitudinal axis 496 by redirecting the light towards a direction 494a, 494b forming an angle α1 relative to the longitudinal axis 496 respectively. As a result, the illumination pattern 498 may be lower along the longitudinal axis 496 as shown in FIG. 4C.

FIG. 4C illustrates a radiation pattern 498 of the light-emitting device 400 shown in FIG. 4A. The radiation pattern 498 may be illustrated in FIG. 4C using a solid line in a radiation graph showing a horizontal “angle of illumination” axis and a vertical “lumen intensity” axis. The angle of illumination may be the angle formed between a light ray relative to the illumination direction Y. For reference purpose, a radiation pattern 497 of a similar device without the roughened area 432 is shown in dashed line. As shown in FIG. 4C, the graph corresponding to the surrounding of the roughened area 432 may have higher intensity compared to the radiation pattern 497 without the roughened area or micro-optics 432. However, along the longitudinal axis 496, the radiation pattern 498 may be lower compared to the radiation pattern 497 without the roughened area 432. In other words, radiation pattern 498 may form a double-peak shape that may be referred as a “butterfly pattern” as shown in FIG. 4C. One application of the light-emitting device 400 having such butterfly radiation pattern may be a tail lamp of an automobile.

FIG. 4D illustrates a tail lamp 491 of a vehicle having the light-emitting device 400 shown in FIG. 4A. The tail lamp 491 of a vehicle may comprise a plurality of light-emitting device 400 disposed on a substrate 411 or a housing 411. Each of the light-emitting devices 400 may be facing a common illumination direction or the illumination direction Y. In use, the roughened area 432 may be effective in reducing glaring effect when the tail lamp is viewed along the illumination direction Y. The reduction of glaring effect may be desirable for safety considerations.

FIG. 5 illustrates a method for directing light to substantially one side of a light-emitting device. In step 510, an emitter mounted on a reflector may be provided. Next, in step 520, the emitter may be encapsulated using an encapsulant on the reflector such that the encapsulant forms an illumination surface facing an illumination direction. In step 530, a plurality of micro-optics may be formed on one side of the illumination surface relative to a vertical axis such that the each of the micro-optics is configured to attenuate light transmitting towards a first direction by redirecting the light towards a second direction respectively. The micro-optics may be formed using hot-press, stamping or a molding process. The first direction may be towards one side of the vertical axis and the second direction may be toward the other side of the vertical axis.

Different aspects, embodiments or implementations may, but need not, yield one or more of the following advantages. For example, the arrangement, the shape and configuration of the roughened areas and/or the micro-optics and/or the optical structure may be beneficial to the application of the light-emitting device. For example, in a vehicle's tail lamp, illumination along an axis may be attenuated to prevent glaring effect whereas in another application such as seaport, the roughened area may concentrate light towards the illumination direction. On the other hand, for display system in stadium, the optical structure may be configured to redirect light towards the audience usually situated below the display system.

Although specific embodiments of the invention have been described and illustrated herein above, the invention should not be limited to any specific forms or arrangements of parts so described and illustrated. For example, light source die described above may be LEDs die or some other future light source die as known or later developed without departing from the spirit of the invention. Likewise, although light-emitting devices were discussed, the embodiments are applicable to optical devices such as proximity sensor and encoders as well as component level such as a light-source packaging to produce the light-emitting devices. The scope of the invention is to be defined by the claims appended hereto and their equivalents.

What is claimed is:

1. A light-emitting device, comprising:
a reflector surface;
an emitter attached on the reflector surface, the emitter being configured to emit light towards an illumination direction;
an encapsulant encapsulating the emitter on the reflector surface;
an illumination surface of the encapsulant being distanced away from the reflector surface; and
a plurality of optical structures formed on at least a portion of the encapsulant,
wherein each of the plurality of optical structures is configured to attenuate light transmitting towards a first direction by redirecting the light towards a second direction respectively.

2. The light-emitting device of claim 1, wherein the plurality of optical structures is configured such that the first direction forms an angle of less than ninety degrees relative to the illumination direction.

3. The light-emitting device of claim 1, wherein the plurality of optical structures is configured such that the second direction forms an angle of less than ninety degrees relative to the illumination direction.

4. The light-emitting device of claim 1, wherein the plurality of optical structures are micro-optics with feature height substantially smaller than five microns.

5. The light-emitting device of claim 1, wherein the plurality of optical structures extends planarly on the illumination surface in an asymmetrical manner.

6. The light-emitting device of claim 1, wherein the at least a portion of the illumination surface where the plurality of optical structures are formed is approximately less than half of the illumination surface.

7. The light-emitting device of claim 1, wherein when the light-emitting device is in a vertical arrangement such that the illumination surface extends substantially vertically relative to a horizontal axis, the portion of the illumination surface above the horizontal axis comprises the plurality of optical structures.

8. The light-emitting device of claim 7, wherein when the light-emitting device is in the vertical arrangement such that the illumination surface extends vertically relative to the horizontal axis, the portion of the illumination surface below the horizontal axis comprises a smooth surface.

9. The light-emitting device of claim 8, wherein when the light-emitting device is in the vertical arrangement such that the illumination surface extends vertically relative to the horizontal axis, the plurality of optical structures are configured to concentrate light towards a direction below the horizontal axis.

10. The light-emitting device of claim 1, wherein each of the plurality of optical structures are shaped in accordance to distance from the emitter.

11. The light-emitting device of claim 1 forms a portion of an electronic display system, wherein the electronic display system comprises at least one additional light-emitting device, wherein the light-emitting device and the at least one additional light-emitting device are arranged in a similar manner so as to attenuate light transmitted towards the first direction by redirecting the light towards the second direction.

12. A flashlight, comprising:
an emitter configured to emit light;
a reflector configured to direct light towards an illumination direction;
an encapsulant encapsulating the emitter and at least partially the reflector;
an illumination surface of the encapsulant facing the illumination direction; and
a roughened area of the illumination surface comprising a plurality of micro-optics,
wherein each of the micro-optics is configured to attenuate light directed towards a first direction forming an angle from the illumination direction by redirecting the light towards the illumination direction.

13. The flashlight of claim 12, wherein the encapsulant comprises a lens portion having the roughened area.

14. The flashlight of claim 13, wherein the roughened area is substantially circular in shape.

15. The flashlight of claim 14, wherein the roughened area and the lens portion are substantially co-axially aligned.

16. The flashlight of claim 12, wherein the flashlight extends along a longitudinal axis, and wherein the roughened area and the plurality of micro-optics are configured to redirect light such that maximum concentration of light are redirected by the plurality of micro-optics substantially along the longitudinal axis.

17. The flashlight of claim 12 forms a portion of light communicating system of a seaport.

18. A light-emitting device, comprising an emitter configured to emit light;
a reflector configured to direct light towards an illumination direction;
an encapsulant encapsulating the emitter and at least partially the reflector;
an illumination surface of the encapsulant facing the illumination direction; and
a roughened area of the illumination surface comprising a plurality of micro-optics approximating the emitter,
wherein the emitter and the roughened area are formed substantially along a longitudinal axis; and
wherein each of the micro-optics is configured to attenuate light directed towards the longitudinal axis by redirecting the light towards a direction forming an angle from the longitudinal axis respectively.

19. The light-emitting device of claim 18, wherein the roughened area is formed in a substantially circular shape with the longitudinal axis located at a central region of the circular shape, and wherein the illumination surface comprises a substantially smooth surface surrounding the roughened area.

20. The light-emitting device of claim 18, wherein the light-emitting device forms a portion of tail lamp of a vehicle.
